(19) United States
(12) Patent Application Publication
(10) Pub. No.: US 2022/0405777 A1
(43) Pub. Date: Dec. 22, 2022

(54) METHODS, SYSTEMS, APPARATUSES, AND DEVICES OF FACILITATING STREAMING OF A DIGITAL CONTENT

(71) Applicant: Jeffery C. Lawrence, Brooklyn, NY (US)

(72) Inventor: Jeffery C. Lawrence, Brooklyn, NY (US)

(21) Appl. No.: 17/845,591

(22) Filed: Jun. 21, 2022

Related U.S. Application Data
(60) Provisional application No. 63/212,851, filed on Jun. 21, 2021.

(51) Int. Cl. G06Q 30/02; H04L 65/61

(52) U.S. Cl. CPC G06Q 30/0201; H04L 65/61

(57) ABSTRACT

Disclosed herein is a method of facilitating streaming of a digital content. Accordingly, the method may include retrieving, using a storage device, the digital content associated with a content provider, transmitting, using a communication device, the digital content to a user device associated with a user, receiving, using the communication device, a content consumption indicator data corresponding to the digital content from the user device, transmitting, using the communication device, a billing information associated with the digital content to the user device, and receiving, using the communication device, a payment information from the user device.

### FIELD OF THE INVENTION

Generally, the present disclosure relates to the field of data processing. More specifically, the present disclosure relates to methods, systems, apparatuses, and devices of facilitating streaming of a digital content.

### BACKGROUND OF THE INVENTION

The field of data processing is technologically important to several industries, business organizations, and/or individuals. In particular, the use of data processing is prevalent for streaming of a digital content.

Digital technology has come a long way in the past few years. One well-known digital technology that has been widely utilized throughout society is the ability to stream particular content such as music, podcasts, etc. There exist many different applications and services which are utilized to stream a wide variety of audios to a subscriber of the application. An issue is that subscribers are often paying more than they should be due to the flat monthly payment. For example, someone who was to subscribe to a music streaming application needs to pay a flat monthly payment to keep the benefits of being a subscriber. If the user does not use the service for a month due to whatever reason, the user may still need to pay for the subscription for the month if they have not canceled their subscription. The unused months of services paid by the subscriber can add up and become a larger fee in the long run which can be a waste of money.

Therefore, there is a need for improved methods, systems, apparatuses, and devices for facilitating streaming of a digital content that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating streaming of a digital content, in accordance with some embodiments. Accordingly, the method may include retrieving, using a storage device, at least one digital content associated with at least one content provider. Further, the method may include transmitting, using a communication device, the at least one digital content to at least one user device associated with at least one user. Further, the method may include receiving, using the communication device, a content consumption indicator data corresponding to the at least one digital content from the at least one user device. Further, the content consumption indicator data represents consumption of the at least one digital content by the at least one user. Further, the method may include transmitting, using the communication device, a billing information associated with the at least one digital content to the at least one user device. Further, the method may include receiving, using the communication device, a payment information from the at least one user device.

Further disclosed herein is a system of facilitating streaming of a digital content, in accordance with some embodiments. Accordingly, the system may include a storage device configured for retrieving at least one digital content associated with at least one content provider. Further, the system may include a communication device communicatively coupled with the storage device. Further, the communication device may be configured for transmitting the at least one digital content to at least one user device associated with at least one user. Further, the communication device may be configured for receiving a content consumption indicator data corresponding to the at least one digital content from the at least one user device. Further, the content consumption indicator data represents consumption of the at least one digital content by the at least one user. Further, the communication device may be configured for transmitting a billing information associated with the at least one digital content to the at least one user device. Further, the communication device may be configured for receiving a payment information from the at least one user device.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a flow chart of a method of facilitating streaming of a digital content, in accordance with some embodiments.

FIG. 2 is a flow chart of a method of facilitating streaming of the digital content, in accordance with some embodiments.

FIG. 3 is a flow chart of a method of facilitating streaming of the digital content, in accordance with some embodiments.

FIG. 4 is a flow chart of a method of facilitating streaming of the digital content, in accordance with some embodiments.

FIG. 5 is a flow chart of a method of facilitating streaming of the digital content, in accordance with some embodiments.

FIG. 6 is a flow chart of a method of facilitating streaming of the digital content, in accordance with some embodiments.

FIG. 7 is a block diagram of a system of facilitating streaming of a digital content, in accordance with some embodiments.

FIG. 8 is a block diagram of the system of facilitating streaming of the digital content, in accordance with some embodiments.

FIG. 9 is a block diagram of the system of facilitating streaming of the digital content, in accordance with some embodiments.

FIG. 10 is a block diagram of the system of facilitating streaming of the digital content, in accordance with some embodiments.

FIG. 11 is an illustration of an online platform consistent with various embodiments of the present disclosure.

FIG. 12 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices of facilitating streaming of a digital content, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods, systems, apparatuses, and devices of facilitating streaming of a digital content. Further, the disclosed system may provide a streaming service that allows users to pay for exactly what is streamed with a direct-to-artist payment method. Further, PennyRadio, an exemplary embodiment of the disclosed system herein, may provide a streaming service that allows the users to pay for what the users listen to. The disclosed system provides a streaming service that does not require the users to pay a flat monthly fee like other existing streaming services. In addition, the disclosed system provides an option to allow the user to donate directly to the artist of the content which is being listened to. In addition, many artists may be relying on streaming as large if not the majority of their income. The disclosed system provides an option to allow the user to donate directly to the artist of the content in which it is being listened to, allowing in many cases for the artist to obtain more income per stream promoting a more sustainable income for the artist.

In addition, a price paid per stream may also be tailored to each individual artist allowing the users (or a user) to decide how much per stream they wish to give to any given artist on the platform. Further, the user may also be allowed to pick a charity to donate to per stream. The disclosed system may be configured for providing user-end interfaces and artist-end interfaces.

Further, the user-end interfaces may be the interactions of the user with the disclosed system. Further, the user may enter their preferred payment method and information according to the requested credentials and details. Further, the payment method may include but is not limited to, credit cards, debit cards, bank account information, PayPal, etc. In addition, during the payment process, the user may edit and choose the option of how often they would like to be billed. Once the payment method, information, and credentials have been provided by the user, the user may then be charged every cycle period in which how often the user wants to pay. Further, the users may be charged with whatever the users wish to pay per stream starting at a minimum of $0.01 United States Dollar (USD). In addition, the user may decide if they want to support a streamed content (or the content) by donating or paying more than what is required based on the pricing of the streamed content. Further, the content may be anything such as audiobooks, music, podcasts, or any audio available. Further, different content may differ in price. For instance, the price of an audiobook may differ from the price of a single song. The user may only be charged once the user has successfully listened through more than 33% of a given song. Further, the disclosed method for charging a user that listens to a song allows the user to only pay for what they have listened to. Thus, the user does not waste money by using a flat rate fee in cases if they did not listen to anything at all.

Further, different content to which the user listens may be billed and charged differently depending on the type of content streamed based on a rate. Further, podcasts and audiobooks may be billed and charged differently than music due to the extended content and length of the audio itself. Further, the podcasts and audiobooks may be billed/charged per minute. For example, if the user listens to three minutes of a podcast/audiobook, the user will be charged USD 0.01. Further, the rate may or may not be charged per minute, charged by a flat rate, or charged by other possible methods that have not been described.

Further, the artist-end interfaces may be the interactions of the artist/audio content creator or provider with the disclosed system. Further, musicians, artists, content creators, etc. may be able to directly upload their music, podcasts, audiobooks, etc. to the website of the present invention. Further, content providers (such as musicians, artists, content creators, etc.) may provide their bank account information respectively in order to receive payments for users listening to their audio content. The content providers may receive their payments directly from the users. Further, the disclosed system may present an interface with a visual meter to the content provider to show how much money has been generated and accumulated by users. In addition, the content provider may be presented with information such as how much total money has been generated, how much money each content has generated, etc.

Further, the disclosed system may be associated with a software platform such as a website that benefits the users and the content providers. Further, all money paid by the user may go directly to the content provider. In addition, the disclosed system may be used to stream advertisements (or ads). The disclosed system may present the ads to the user depending on the payment of the user. For instance, if the user decides to pay more than the minimum, the user may not be presented with the ads. In addition, the advertisements may come in different shapes and forms such as an audio ad during the streaming of an audio, an ad banner/image presented on the website, etc. In addition, society is at a time where many artists are relying on streaming as large, if not the majority of their income. The disclosed system provides an option to allow the user to donate directly to the artist of the content which is being listened to, allowing in many cases for the artist to obtain more income per stream promoting a more sustainable income for the artist.

Further, in an embodiment, the disclosed system may be configured for video streaming in the same manner as the explained method and system of audio content. Further, the ability for video streaming by the disclosed system may be an extension of the website or a separate website.

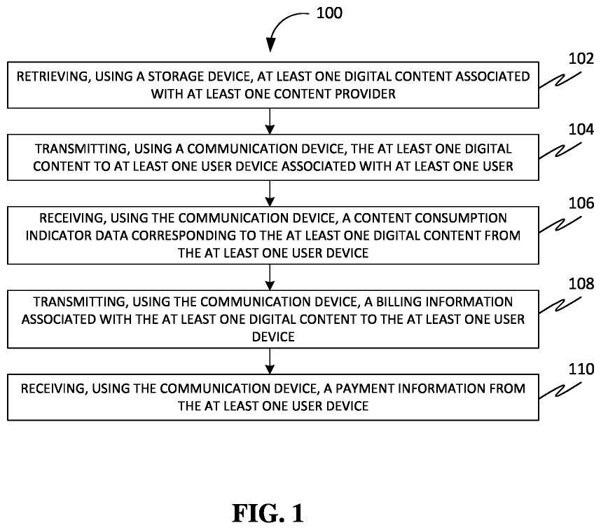

Referring now to figures, FIG. 1 is a flow chart of a method 100 of facilitating streaming of a digital content, in accordance with some embodiments. Accordingly, at 102, the method 100 may include retrieving, using a storage device (such as a storage device 704), at least one digital content associated with at least one content provider.

Further, at 104, the method 100 may include transmitting, using a communication device (such as a communication device 702), the at least one digital content to at least one user device (such as at least one user device 804) associated with at least one user. Further, the at least one user device may include a smartphone, a tablet, a laptop, a desktop, and so on. Further, the at least one user may include an individual, an institution, and an organization that may want to stream the at least one digital content. Further, the at least one digital content may include audiobook, music, podcasts, an audio, a video, an audio-video, etc.

Further, at 106, the method 100 may include receiving, using the communication device, a content consumption indicator data corresponding to the at least one digital content from the at least one user device. Further, the content consumption indicator data represents consumption of the at least one digital content by the at least one user.

Further, at 108, the method 100 may include transmitting, using the communication device, a billing information associated with the at least one digital content to the at least one user device.

Further, at 110, the method 100 may include receiving, using the communication device, a payment information from the at least one user device.

Further, in some embodiments, the method 100 may include storing, using the storage device, the billing information and the payment information in a distributed ledger. Further, the distributed ledger may include a blockchain. Further, the storing the payment information and the billing information in the distributed ledger may prevent unfair activities such as fraud, fake claims, fake consumption of the at least one digital content, etc.

Further, in some embodiments, the method 100 may include transmitting, using the communication device, at least one advertisement content based on the transmitting of the at least one digital content.

Further, in some embodiments, the billing information may be associated with a price. Further, the price may include a consumption price to be paid for the consumption of the at least one digital content and an additional price. Further, the transmitting of the at least one advertisement content may be based on the payment information received corresponding to the billing information. Further, the at least one user pays the additional price along with the consumption price to not be presented with the at least one advertisement content. Further, in some embodiments, the additional price may include a donation amount for at least one content provider creating the at least one digital content.

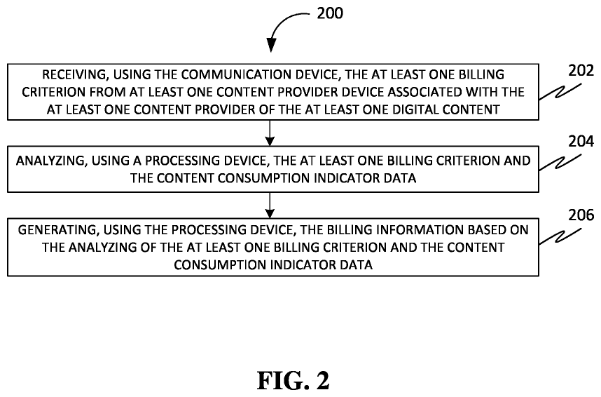

FIG. 2 is a flow chart of a method 200 of facilitating streaming of the digital content, in accordance with some embodiments. Accordingly, the billing information associated with the at least one digital content may be based on at least one billing criterion. Further, at 202, the method 200 may include receiving, using the communication device, the at least one billing criterion from at least one content provider device (such as at least one content provider device 806) associated with the at least one content provider of the at least one digital content.

Further, at 204, the method 200 may include analyzing, using a processing device, the at least one billing criterion and the content consumption indicator data.

Further, at 206, the method 200 may include generating, using the processing device, the billing information based on the analyzing of the at least one billing criterion and the content consumption indicator data.

Further, in some embodiments, the method 200 may include storing, using the storage device, the at least one billing criterion. Further, the storing the at least one billing criterion may include storing the at least one billing criterion in the distributed ledger.

Further, in some embodiments, a first digital content of the at least one digital content may be associated with a first billing criterion of the at least one billing criterion and a second digital content of the at least one digital content may be associated with a second billing criterion of the at least one billing criterion. Further, the first billing criterion may be dissimilar from the second billing criterion.

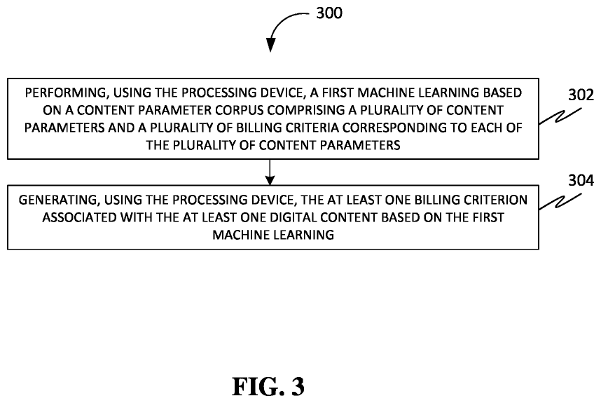

FIG. 3 is a flow chart of a method 300 of facilitating streaming of the digital content, in accordance with some embodiments. Accordingly, at 302, the method 300 may include performing, using the processing device, a first machine learning based on a content parameter corpus comprising a plurality of content parameters and a plurality of billing criteria corresponding to each of the plurality of content parameters.

Further, at 302, the method 300 may include generating, using the processing device, the at least one billing criterion associated with the at least one digital content based on the first machine learning.

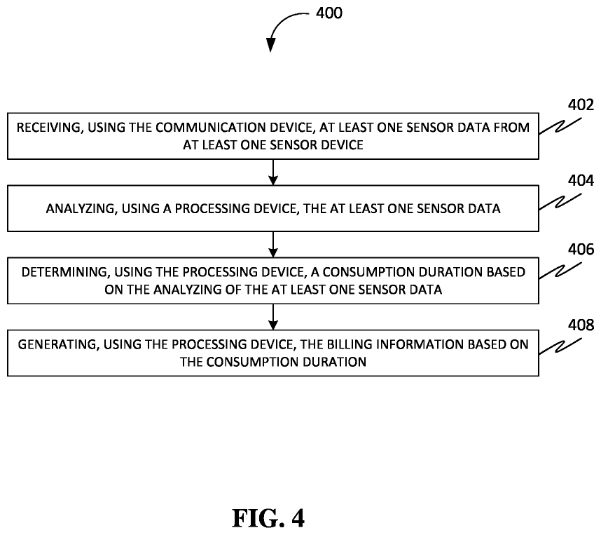

FIG. 4 is a flow chart of a method 400 of facilitating streaming of the digital content, in accordance with some embodiments. Accordingly, at 402, the method 400 may include receiving, using the communication device, at least one sensor data from at least one sensor device (such as at least one sensor device 904). Further, the at least one sensor device may be configured for generating the at least one sensor data based on monitoring the consumption of the at least one digital content. Further, the at least one sensor device may include an audio sensor, an image sensor, etc. Further, in an embodiment, the at least one sensor device may be comprised in a content output device (such as the at least one user device). Further, the content output device may include a speaker, an earphone, a headphone, a watch, a smart watch, a television, a smart television, etc. Further, the content output device may be configured for presenting the at least one digital content.

Further, at 404, the method 400 may include analyzing, using a processing device, the at least one sensor data.

Further, at 406, the method 400 may include determining, using the processing device, a consumption duration based on the analyzing of the at least one sensor data. Further, the consumption duration may represent a time duration for which the at least one user consumed the at least one digital content.

Further, at 408, the method 400 may include generating, using the processing device, the billing information based on the consumption duration.

Further, in some embodiments, the method 400 may include storing, using the storage device, the consumption duration and the at least one sensor data. Further, the storing the consumption duration and the at least one sensor data may include storing the consumption duration and the at least one sensor data in the distributed ledger.

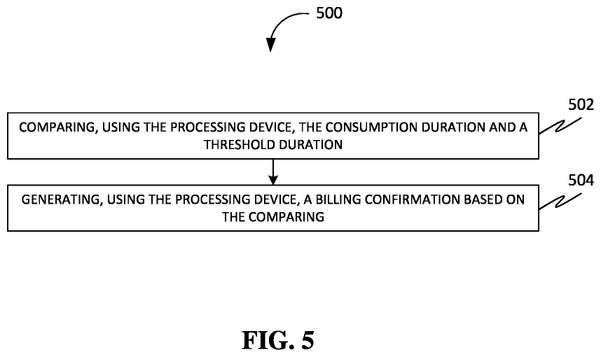

FIG. 5 is a flow chart of a method 500 of facilitating streaming of the digital content, in accordance with some embodiments. Accordingly, at 502, the method 500 may include comparing, using the processing device, the consumption duration and a threshold duration. Further, the threshold duration may represent a minimum duration for which the at least one user may consume the at least one digital content to be billed for the at least one digital content. Further, in an instance, the threshold duration may be 33% of a length of a song.

Further, at 504, the method 500 may include generating, using the processing device, a billing confirmation based on the comparing. Further, the generating of the billing information may be based on the billing confirmation.

Further, in some embodiments, the method 500 may include storing, using the storage device, the billing confirmation. Further, the storing the billing confirmation may include storing the billing confirmation in the distributed ledger.

Further, in some embodiments, the at least one sensor device may be comprised in the at least one user device. Further, the at least one sensor device may include a microphone, a display screen, a camera, etc. comprised in the at least one user device.

Further, in some embodiments, the at least one sensor device may be disposed in a surrounding environment of the at least one user. Further, the at least one sensor device disposed in the surrounding environment may include a motion sensor, an image sensor, an audio sensor, a physiological sensor, etc. Further, the physiological sensor may be configured for monitoring a physiological state of the at least one user. Further, the physiological state may include a happy state, a sad state, a relaxed state, etc. Further, the physiological sensor may include a heart rate sensor, a blood pressure sensor, etc. Further, the motion sensor may be configured for monitoring a physical state or actions of the at least one user. Further, the physical actions may include the at least one user dancing, bobbing, jumping, etc.

Further, in some embodiments, the method 500 may include determining, using the processing device, at least one user response corresponding to the consumption of the at least one digital content by the at least one user based on the analyzing of the at least one sensor data. Further, the generating of the billing information may be based on the at least one user response. Further, the at least one user response may include physical movements (such as dancing, rocking, bobbing, etc.) that may indicate enjoyment. Further, in an embodiment, the at least one user response may include the at least one user hooting and shouting that may indicate enjoyment. Further, in some embodiments, the at least one user response may be based on the physiological state or reactions (such as lowering of heart rate and blood pressure) indicating that the at least one user feels relaxed upon consuming the at least one digital content.

Further, in some embodiments, the generating of the at least one billing criterion may be based on the at least one user response.

Further, in some embodiments, the method 500 may include storing, using the storage device, the at least one user response. Further, the storing the at least one user response may include storing the at least one user response in the distributed ledger.

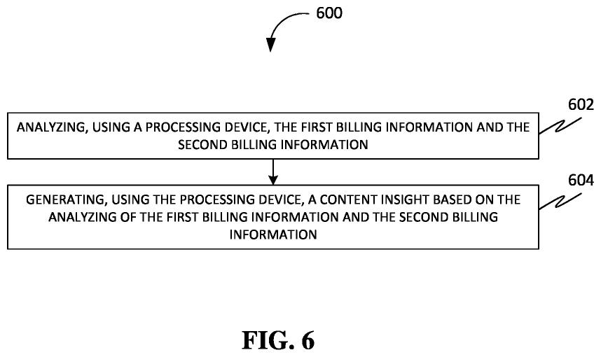

FIG. 6 is a flow chart of a method 600 of facilitating streaming of the digital content, in accordance with some embodiments. Accordingly, the billing information may include a first billing information associated with consumption of a first digital content of the at least one digital content by the at least one user and a second billing information associated with consumption of a second digital content of the at least one digital content by the at least one user. Further, at 602, the method 600 may include analyzing, using a processing device, the first billing information and the second billing information.

Further, at 604, the method 600 may include generating, using the processing device, a content insight based on the analyzing of the first billing information and the second billing information. Further, the content insight may include a graphical representation representing revenue generated by the consumption of the first digital content and the second digital content. Further, the content insight may include a visual meter indicating how much money or revenue has been generated and accumulated by the at least one user. In addition, the content insight may present information such as how much total money has been generated, how much money each content has generated, etc.

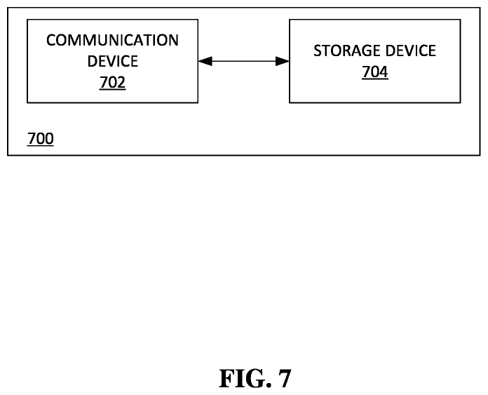

FIG. 7 is a block diagram of a system 700 of facilitating streaming of a digital content, in accordance with some embodiments. Accordingly, the system 700 may include a storage device 704 configured for retrieving at least one digital content associated with at least one content provider.

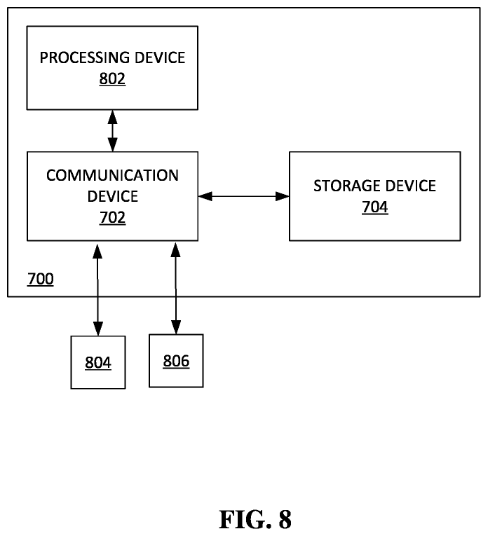

Further, the system 700 may include a communication device 702 communicatively coupled with the storage device 704. Further, the communication device 702 may be configured for transmitting the at least one digital content to at least one user device 804 (as shown in FIG. 8) associated with at least one user. Further, the communication device 702 may be configured for receiving a content consumption indicator data corresponding to the at least one digital content from the at least one user device 804. Further, the content consumption indicator data represents consumption of the at least one digital content by the at least one user. Further, the communication device 702 may be configured for transmitting a billing information associated with the at least one digital content to the at least one user device 804. Further, the communication device 702 may be configured for receiving a payment information from the at least one user device 804.

Further, in some embodiments, the billing information associated with the at least one digital content may be based on at least one billing criterion. Further, the communication device 702 may be configured for receiving the at least one billing criterion from at least one content provider device 806 (as shown in FIG. 8) associated with the at least one content provider of the at least one digital content. Further, the system 700 may include a processing device 802 (as shown in FIG. 8) communicatively coupled with the communication device 702. Further, the processing device 802 may be configured for analyzing the at least one billing criterion and the content consumption indicator data. Further, the processing device 802 may be configured for generating the billing information based on the analyzing of the at least one billing criterion and the content consumption indicator data.

Further, in some embodiments, a first digital content of the at least one digital content may be associated with a first billing criterion of the at least one billing criterion and a second digital content of the at least one digital content may be associated with a second billing criterion of the at least one billing criterion. Further, the first billing criterion may be dissimilar from the second billing criterion.

Further, in some embodiments, the processing device 802 may be configured for performing a first machine learning based on a content parameter corpus comprising a plurality of content parameters and a plurality of billing criteria corresponding to each of the plurality of content parameters. Further, the processing device 802 may be configured for generating the at least one billing criterion associated with the at least one digital content based on the first machine learning.

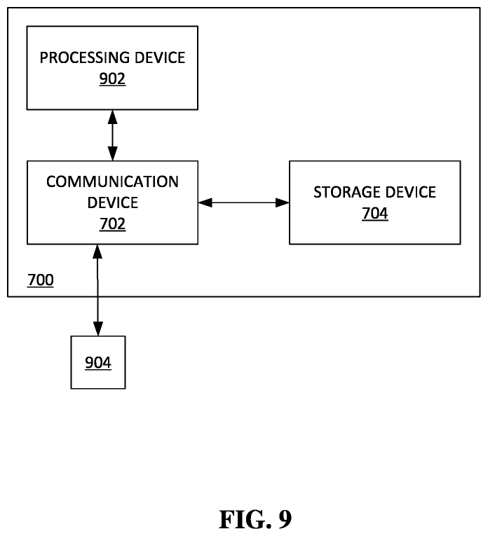

Further, in some embodiments, the communication device 702 may be configured for receiving at least one sensor data from at least one sensor device 904 (as shown in FIG. 9). Further, the at least one sensor device 904 may be configured for generating the at least one sensor data based on monitoring the consumption of the at least one digital content. Further, the system 700 may include a processing device 902 (as shown in FIG. 9) communicatively coupled with the communication device 702. Further, the processing device 902 may be configured for analyzing the at least one sensor data. Further, the processing device 902 may be configured for determining a consumption duration based on the analyzing of the at least one sensor data. Further, the processing device 902 may be configured for generating the billing information based on the consumption duration.

Further, in some embodiments, the processing device 902 may be configured for comparing the consumption duration and a threshold duration. Further, the processing device 902 may be configured for generating a billing confirmation based on the comparing. Further, the generating of the billing information may be based on the billing confirmation. Further, the billing confirmation may indicate that the at least one user consumed the at least one digital content above the threshold duration.

Further, in some embodiments, the at least one sensor device 904 may be comprised in the at least one user device 804.

Further, in some embodiments, the at least one sensor device 904 may be disposed in a surrounding environment of the at least one user.

Further, in some embodiments, the processing device 902 may be configured for determining at least one user response corresponding to the consumption of the at least one digital content by the at least one user based on the analyzing of the at least one sensor data. Further, the generating of the billing information may be based on the at least one user response.

Further, in some embodiments, the generating of the at least one billing criterion may be based on the at least one user response.

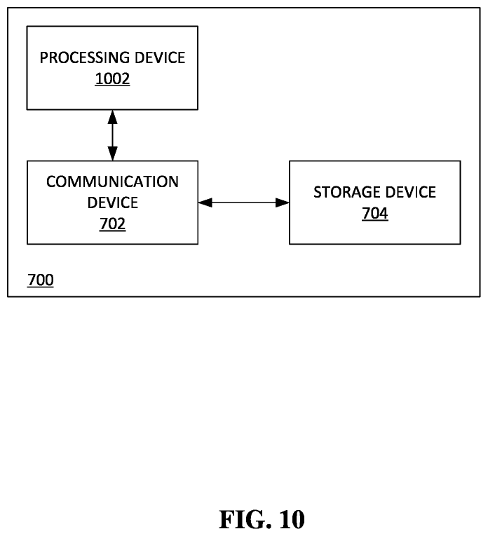

Further, in some embodiments, the billing information may include a first billing information associated with consumption of a first digital content of the at least one digital content by the at least one user and a second billing information associated with consumption of a second digital content of the at least one digital content by the at least one user. Further, the system 700 may include a processing device 1002 (as shown in FIG. 10) communicatively coupled with the communication device 702. Further, the processing device 1002 may be configured for analyzing the first billing information and the second billing information. Further, the processing device 1002 may be configured for generating a content insight based on the analyzing of the first billing information and the second billing information. Further, the content insight may include a graphical representation representing revenue generated by the consumption of the first digital content and the second digital content.

FIG. 8 is a block diagram of the system 700 of facilitating streaming of the digital content, in accordance with some embodiments.

FIG. 9 is a block diagram of the system 700 of facilitating streaming of the digital content, in accordance with some embodiments.

FIG. 10 is a block diagram of the system 700 of facilitating streaming of the digital content, in accordance with some embodiments.

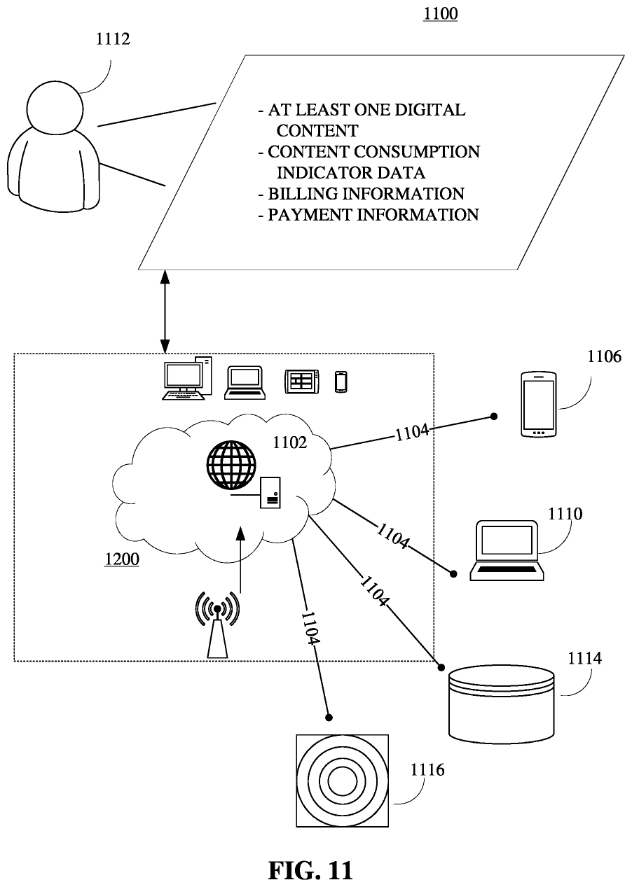

FIG. 11 is an illustration of an online platform 1100 consistent with various embodiments of the present disclosure. By way of non-limiting example, the online platform 1100 of facilitating streaming of a digital content may be hosted on a centralized server 1102, such as, for example, a cloud computing service. The centralized server 1102 may communicate with other network entities, such as, for example, a mobile device 1106 (such as a smartphone, a laptop, a tablet computer, etc.), other electronic devices 1110 (such as desktop computers, server computers, etc.), databases 1114, and sensors 1116 over a communication network 1104, such as, but not limited to, the Internet. Further, users of the online platform 1100 may include relevant parties such as, but not limited to, end-users, administrators, service providers, service consumers and so on. Accordingly, in some instances, electronic devices operated by the one or more relevant parties may be in communication with the platform.

A user 1112, such as the one or more relevant parties, may access online platform 1100 through a web-based software application or browser. The web-based software application may be embodied as, for example, but not be limited to, a website, a web application, a desktop application, and a mobile application compatible with a computing device 1200.

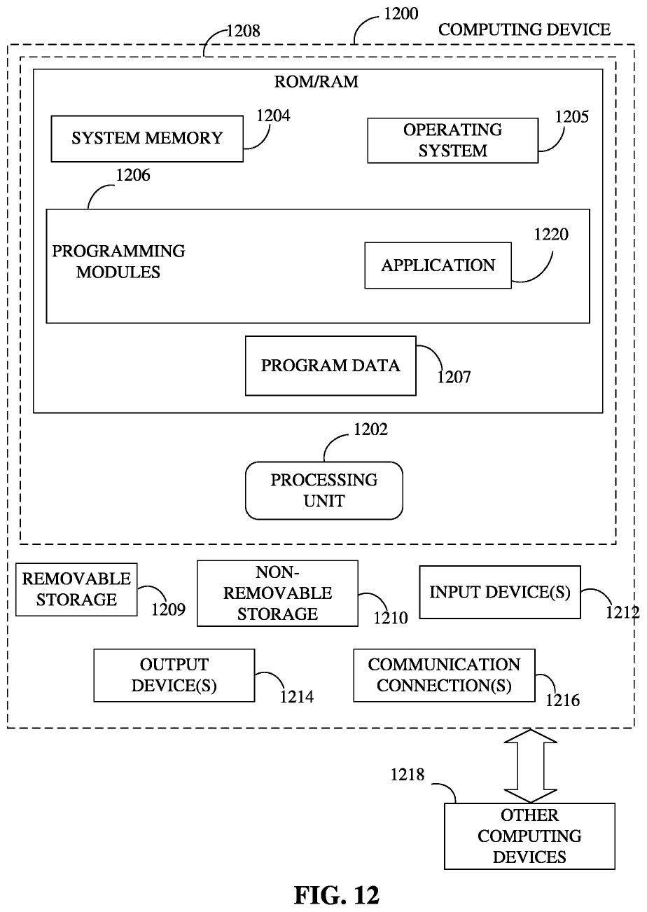

With reference to FIG. 12, a system consistent with an embodiment of the disclosure may include a computing device or cloud service, such as computing device 1200. In a basic configuration, computing device 1200 may include at least one processing unit 1202 and a system memory 1204. Depending on the configuration and type of computing device, system memory 1204 may comprise, but is not limited to, volatile (e.g. random-access memory (RAM)), non-volatile (e.g. read-only memory (ROM)), flash memory, or any combination. System memory 1204 may include operating system 1205, one or more programming modules 1206, and may include a program data 1207. Operating system 1205, for example, may be suitable for controlling computing device 1200's operation. In one embodiment, programming modules 1206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 12 by those components within a dashed line 1208.

Computing device 1200 may have additional features or functionality. For example, computing device 1200 may also include additional data storage devices (removable and/or non-removable) such as, for example, magnetic disks, optical disks, or tape. Such additional storage is illustrated in FIG. 12 by a removable storage 1209 and a non-removable storage 1210. Computer storage media may include volatile and non-volatile, removable and non-removable media implemented in any method or technology for storage of information, such as computer-readable instructions, data structures, program modules, or other data. System memory 1204, removable storage 1209, and non-removable storage 1210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1200. Any such computer storage media may be part of device 1200. Computing device 1200 may also have input device(s) 1212 such as a keyboard, a mouse, a pen, a sound input device, a touch input device, a location sensor, a camera, a biometric sensor, etc. Output device(s) 1214 such as a display, speakers, a printer, etc. may also be included. The aforementioned devices are examples and others may be used.

Computing device 1200 may also contain a communication connection 1216 that may allow device 1200 to communicate with other computing devices 1218, such as over a network in a distributed computing environment, for example, an intranet or the Internet. Communication connection 1216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1204, including operating system 1205. While executing on processing unit 1202, programming modules 1206 (e.g., application 1220) may perform processes including, for example, one or more stages of methods, algorithms, systems, applications, servers, databases as described above. The aforementioned process is an example, and processing unit 1202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method of facilitating streaming of digital content, the method comprising:
retrieving, using a storage device, at least one digital content associated with at least one content provider;
transmitting, using a communication device, the at least one digital content to at least one user device associated with at least one user;
receiving, using the communication device, a content consumption indicator data corresponding to the at least one digital content from the at least one user device, wherein the content consumption indicator data represents consumption of the at least one digital content by the at least one user;
transmitting, using the communication device, a billing information associated with the at least one digital content to the at least one user device; and
receiving, using the communication device, a payment information from the at least one user device.

2. The method of claim 1, wherein the billing information associated with the at least one digital content is based on at least one billing criterion, wherein the method further comprising:
receiving, using the communication device, the at least one billing criterion from at least one content provider device associated with the at least one content provider of the at least one digital content;
analyzing, using a processing device, the at least one billing criterion and the content consumption indicator data; and
generating, using the processing device, the billing information based on the analyzing of the at least one billing criterion and the content consumption indicator data.

3. The method of claim 2, wherein a first digital content of the at least one digital content is associated with a first billing criterion of the at least one billing criterion and a second digital content of the at least one digital content is associated with a second billing criterion of the at least one billing criterion, wherein the first billing criterion is dissimilar from the second billing criterion.

4. The method of claim 2 further comprising:
performing, using the processing device, a first machine learning based on a content parameter corpus comprising a plurality of content parameters and a plurality of billing criteria corresponding to each of the plurality of content parameters; and
generating, using the processing device, the at least one billing criterion associated with the at least one digital content based on the first machine learning.

5. The method of claim 1 further comprising:
receiving, using the communication device, at least one sensor data from at least one sensor device, wherein the at least one sensor device is configured for generating the at least one sensor data based on monitoring the consumption of the at least one digital content;
analyzing, using a processing device, the at least one sensor data;
determining, using the processing device, a consumption duration based on the analyzing of the at least one sensor data; and
generating, using the processing device, the billing information based on the consumption duration.

6. The method of claim 5 further comprising:
comparing, using the processing device, the consumption duration and a threshold duration; and
generating, using the processing device, a billing confirmation based on the comparing, wherein the generating of the billing information is further based on the billing confirmation.

7. The method of claim 5, wherein the at least one sensor device is comprised in the at least one user device.

8. The method of claim 5, wherein the at least one sensor device is disposed in a surrounding environment of the at least one user.

9. The method of claim 5 further comprises determining, using the processing device, at least one user response corresponding to the consumption of the at least one digital content by the at least one user based on the analyzing of the at least one sensor data, wherein the generating of the billing information is further based on the at least one user response.

10. The method of claim 1, wherein the billing information comprises a first billing information associated with consumption of a first digital content of the at least one digital content by the at least one user and a second billing information associated with consumption of a second digital content of the at least one digital content by the at least one user, wherein the method further comprises:
analyzing, using a processing device, the first billing information and the second billing information; and
generating, using the processing device, a content insight based on the analyzing of the first billing information and the second billing information, wherein the content insight comprises a graphical representation representing revenue generated by the consumption of the first digital content and the second digital content.

11. A system of facilitating streaming of digital content, the system comprising:
a storage device configured for retrieving at least one digital content associated with at least one content provider; and
a communication device communicatively coupled with the storage device, wherein the communication device is further configured for:
transmitting the at least one digital content to at least one user device associated with at least one user;
receiving a content consumption indicator data corresponding to the at least one digital content from the at least one user device, wherein the content consumption indicator data represents consumption of the at least one digital content by the at least one user;
transmitting a billing information associated with the at least one digital content to the at least one user device; and
receiving a payment information from the at least one user device.

12. The system of claim 11, wherein the billing information associated with the at least one digital content is based on at least one billing criterion, wherein the communication device is further configured for receiving the at least one billing criterion from at least one content provider device associated with the at least one content provider of the at least one digital content, wherein the system comprises a processing device communicatively coupled with the communication device, wherein the processing device is further configured for:
analyzing the at least one billing criterion and the content consumption indicator data; and
generating the billing information based on the analyzing of the at least one billing criterion and the content consumption indicator data.

13. The system of claim 12, wherein a first digital content of the at least one digital content is associated with a first billing criterion of the at least one billing criterion and a second digital content of the at least one digital content is associated with a second billing criterion of the at least one billing criterion, wherein the first billing criterion is dissimilar from the second billing criterion.

14. The system of claim 12, wherein the processing device is further configured for:
performing a first machine learning based on a content parameter corpus comprising a plurality of content parameters and a plurality of billing criteria corresponding to each of the plurality of content parameters; and
generating the at least one billing criterion associated with the at least one digital content based on the first machine learning.

15. The system of claim 11, wherein the communication device is further configured for receiving at least one sensor data from at least one sensor device, wherein the at least one sensor device is configured for generating the at least one sensor data based on monitoring the consumption of the at least one digital content, wherein the system comprises a processing device communicatively coupled with the communication device, wherein the processing device is further configured for:
analyzing the at least one sensor data;
determining a consumption duration based on the analyzing of the at least one sensor data; and
generating the billing information based on the consumption duration.

16. The system of claim 15, wherein the processing device is further configured for:
comparing the consumption duration and a threshold duration; and
generating a billing confirmation based on the comparing, wherein the generating of the billing information is further based on the billing confirmation.

17. The system of claim 15, wherein the at least one sensor device is comprised in the at least one user device.

18. The system of claim 15, wherein the at least one sensor device is disposed in a surrounding environment of the at least one user.

19. The system of claim 15, wherein the processing device is further configured for determining at least one user response corresponding to the consumption of the at least one digital content by the at least one user based on the analyzing of the at least one sensor data, wherein the generating of the billing information is further based on the at least one user response.

20. The system of claim 11, wherein the billing information comprises a first billing information associated with consumption of a first digital content of the at least one digital content by the at least one user and a second billing information associated with consumption of a second digital content of the at least one digital content by the at least one user, wherein the system comprises a processing device communicatively coupled with the communication device, wherein the processing device is further configured for:
analyzing the first billing information and the second billing information; and
generating a content insight based on the analyzing of the first billing information and the second billing information, wherein the content insight comprises a graphical representation representing revenue generated by the consumption of the first digital content and the second digital content.
